(19) United States
(12) Patent Application Publication
(10) Pub. No.: US 2018/0264494 A1
(43) Pub. Date: Sep. 20, 2018

(54) Sports Water Bottle with Mister

(71) Applicant: Ever Win International Corporation, City of Industry, CA (US)

(72) Inventors: Yasuhiro Yamamoto, Los Angeles, CA (US); Mae Hsu, Pasadena, CA (US)

(73) Assignee: Ever Win International Corporation, City of Industry, CA (US)

(21) Appl. No.: 15/459,396

(22) Filed: Mar. 15, 2017

(51) Int. Cl. B05B 11/00; A45F 3/18; B65D 1/02; B65D 55/16; B65D 41/04

(52) U.S. Cl. CPC B05B 11/0086; A45F 3/18; B65D 1/0246; B05B 15/005; B65D 41/04; B05B 11/3047; B05B 11/3059; B65D 55/16

(57) ABSTRACT

A sports water bottle with mister is a portable water bottle with a dual function top affixed to it that is capable of both a large flow of water for drinking and also spraying of water for cooling. The dual function top comprises a fixed nozzle that functions as a water flow opening and a spray nozzle with a pump actuator to actuate a pump mechanism to force the water in the water bottle out through the spray nozzle in the dual function top.

### BACKGROUND

### Field of Invention

The present invention relates generally to water bottles. More specifically, the present invention relates to a water bottle that uses a unitary dual function top to enable the user to either drink from the dual function top or spray water from the nozzle in the dual function top.

### Description of Related Art

Water bottles are commonly used to store and carry water. Small portable water bottles are commonly used by people engaging in sports activities to carry water with them for drinking. Traditionally, portable water bottles are manufactured from plastic materials for its low cost and light weight. These portable water bottles are generally elongated cylinders with a sealed bottom and with a threaded opening at the top that is closed by a matching threaded plastic cap. To drink water from these portable water bottles, the user must first remove the threaded cap and then pour the water out from the threaded opening. After drinking, the user must replace the threaded cap on the threaded opening to close the portable water bottle and prevent foreign matters from entering the portable water bottle and contaminate the water therein.

An improved version of the portable water bottle for drinking replaces the threaded cap with a reclosable nozzle that is operated by pulling and pushing on the reclosable nozzle to open and close the nozzle. Generally, by pulling on the reclosable nozzle, a water path is opened through the top of the reclosable nozzle to enable the water to flow out of the portable water bottle. By pushing down on the reclosable nozzle, the water path is sealed and no water will flow out of the portable water bottle and the water inside the portable water bottle is sealed from foreign contaminants.

Small portable water bottles are also used for spraying water for its cooling effects either during hot weather or during vigorous exercise. These portable water bottles are commonly equipped with a pump mechanism that forces the water out through a small nozzle that either sprays the water in a stream, spray, or a misting pattern. The pump mechanism is commonly actuated by the user by squeezing a trigger. Actuation of the pump mechanism forces the water out through the nozzle. The water spray, particularly in a misting form, has a cooling effect as it absorbs the heat energy and evaporates.

For a portable water bottle to have both the water drinking function and water spraying function, prior arts require two separate openings in the portable water bottle and two separate nozzles affixed to the portable water bottle. This increases both the complexity and the cost of the portable water bottle.

### BRIEF SUMMARY OF THE INVENTION

The sports water bottle with mister is a portable water bottle with a dual function top affixed to it that is capable of both a large flow of water for drinking and also spraying of water for cooling. The dual function top has a fixed nozzle that functions as a water flow opening and a spray nozzle with a pump mechanism to force the water contained therein out through the spray nozzle in the dual function top. An elongated tube is affixed under the dual function top and extends to near the bottom of the portable water bottle to enable the extraction of the water through the spray nozzle.

The sports water bottle of the present invention only has a unitary dual function top that functions both as a drinking opening and also as a pump with a spray nozzle. The dual function top may be retrofitted to most preexisting water bottles that have a threaded cap, a reclosable drinking cap, or a spray nozzle. The sports water bottle of the present invention is multifunctional and is easy to operate with a unitary dual function top.

### BRIEF DESCRIPTION OF THE DRAWINGS

FIG. 1 shows a perspective view of the preferred embodiment of the dual function top.

FIG. 2 shows a perspective view of the preferred embodiment of the dual function top with the optional security/safety tab removed.

FIG. 3 shows a perspective view of the preferred embodiment of the dual function top with the optional security/safety tab removed and the flip top cap in the open position.

FIG. 4 shows another perspective view of the preferred embodiment of the dual function top with the pump actuator in the up/uncompressed position.

FIG. 5 shows another perspective view of the preferred embodiment of the dual function top with the pump actuator in the down/compressed position.

FIG. 6 shows another perspective view of the preferred embodiment of the dual function top with the pump actuator in the down/compressed position and the flip top cap in the open position.

FIG. 7 shows a perspective exploded view of the preferred embodiment of the dual function top.

FIG. 8 shows a perspective cut-away view of the preferred embodiment of the dual function top with the flip top cap in the open position.

FIG. 9 shows another perspective cut-away view of the preferred embodiment of the dual function top with the flip top cap in the open position.

### DETAILED DESCRIPTION OF THE PREFERRED EMBODIMENT

The following description and figures are meant to be illustrative only and not limiting. Other embodiments of this invention will be apparent to those of ordinary skill in the art in view of this description.

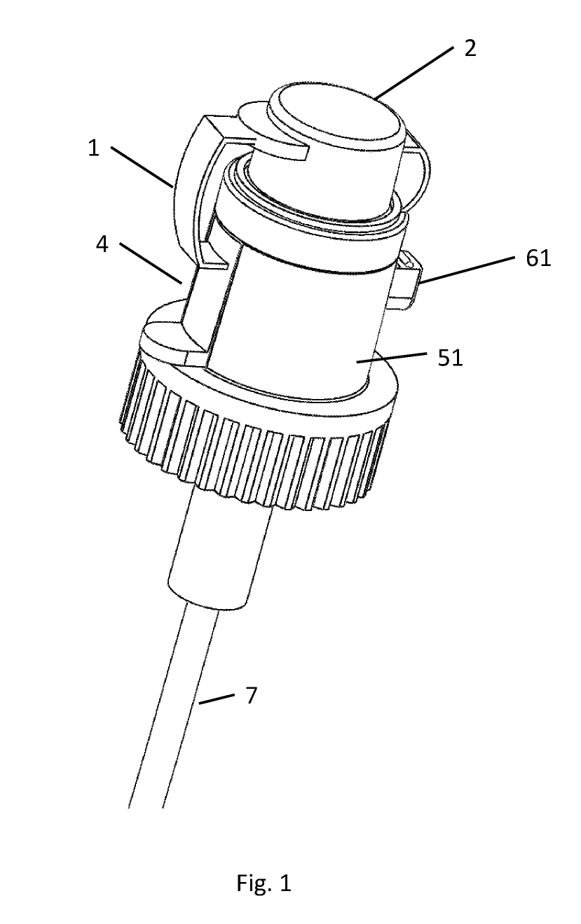

The sports water bottle with mister as shown in FIG. 1 is a portable water bottle 3 with a dual function top 4 affixed to it that is capable of both a large flow of water for drinking and also spraying of water for cooling. In the preferred embodiment, the water bottle 3 is a cylindrical plastic container with a sealed bottom and a constricted open top with a threaded opening. The water bottle 3 may also be made of other suitable materials such as aluminum or other metal alloys. The water bottle 3 may also be in different shapes other than cylindrical.

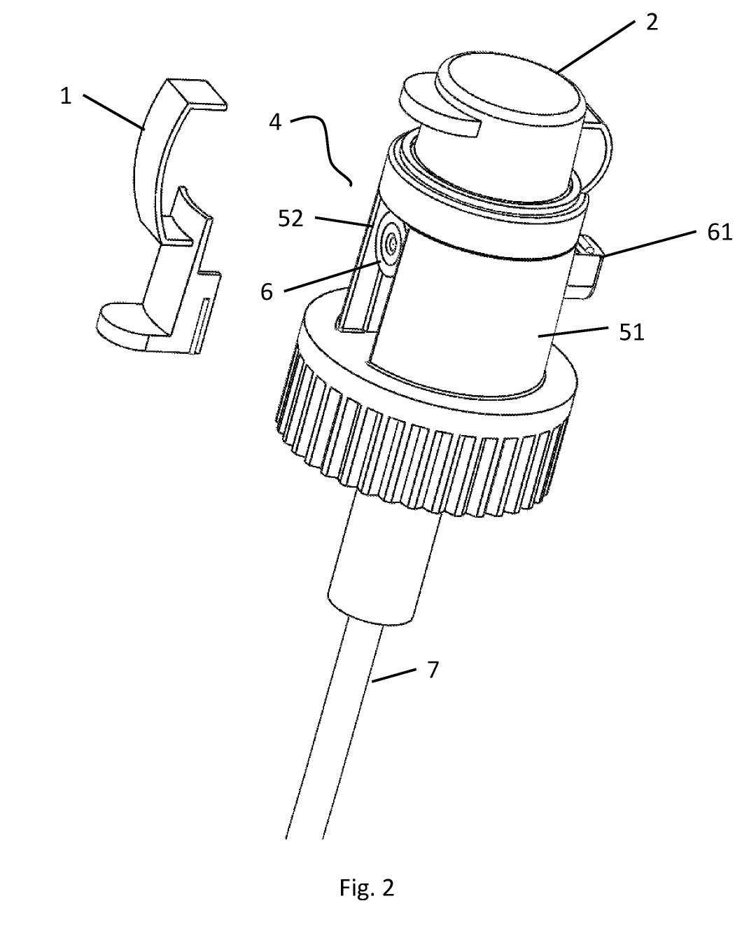

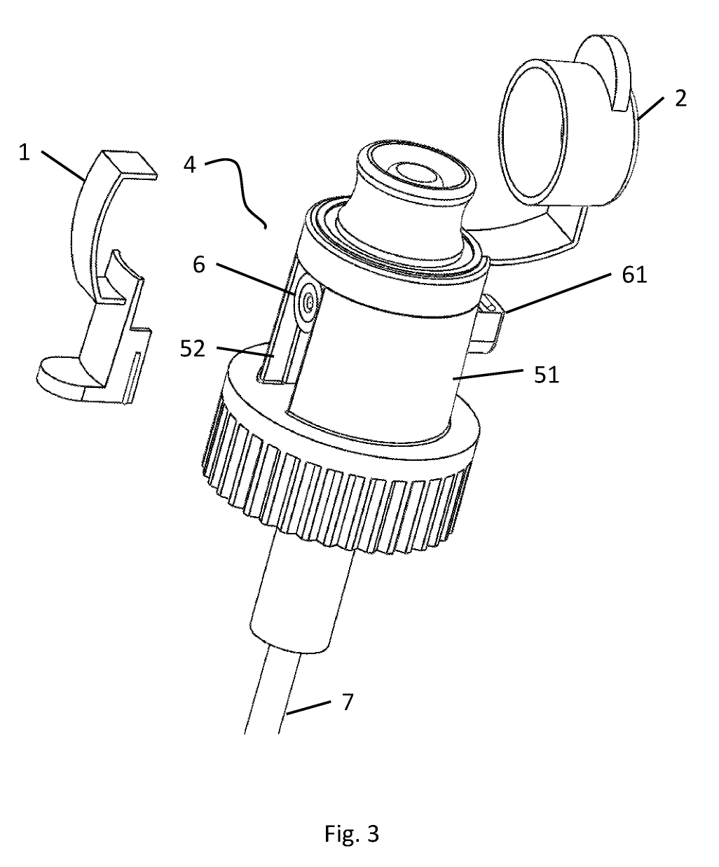

In the preferred embodiment, the dual function top 4 has a threaded bottom that acts as a cap to removably attach to the threaded opening on the water bottle 3 thereby closing the opening of the water bottle 3. A flip top cap 2 is attached to the top of the dual function top 4 and functions as a cap to seal the opening 53 of the fixed nozzle 5 at the top of the dual function top 4. As shown in FIGS. 1 through 3, a removable security/safety tab 1 may be fitted on the dual function top 4, covering the spray nozzle 6. The security/safety tab 1 will prevent unintentional actuation of the pump actuator 61 and the unintentional opening of the flip top cap 2. The security/safety tab 1 will be removed prior to use of the dual function top 4.

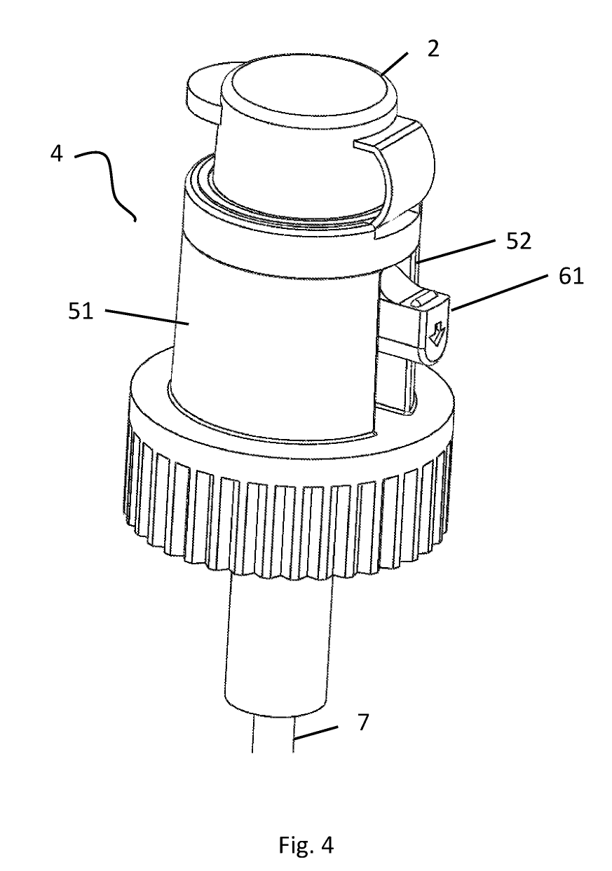

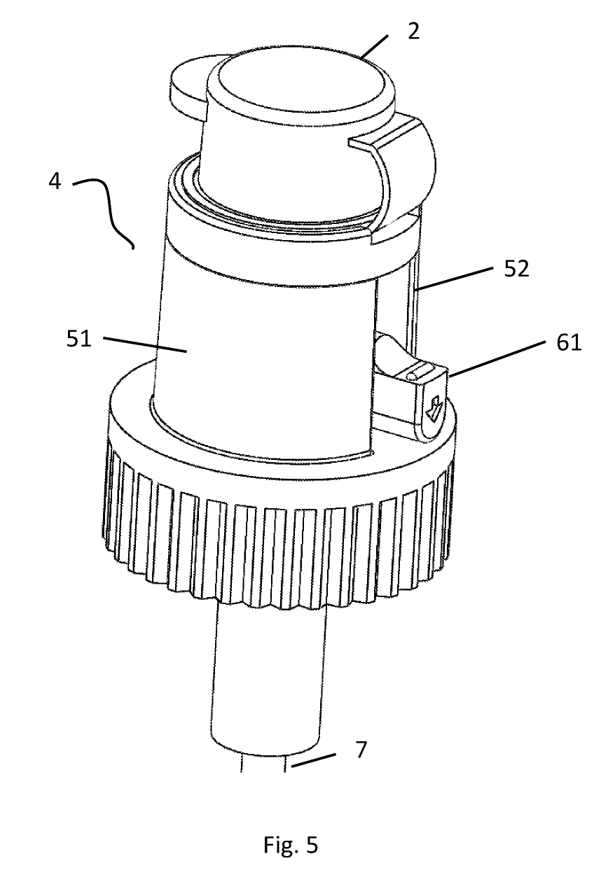

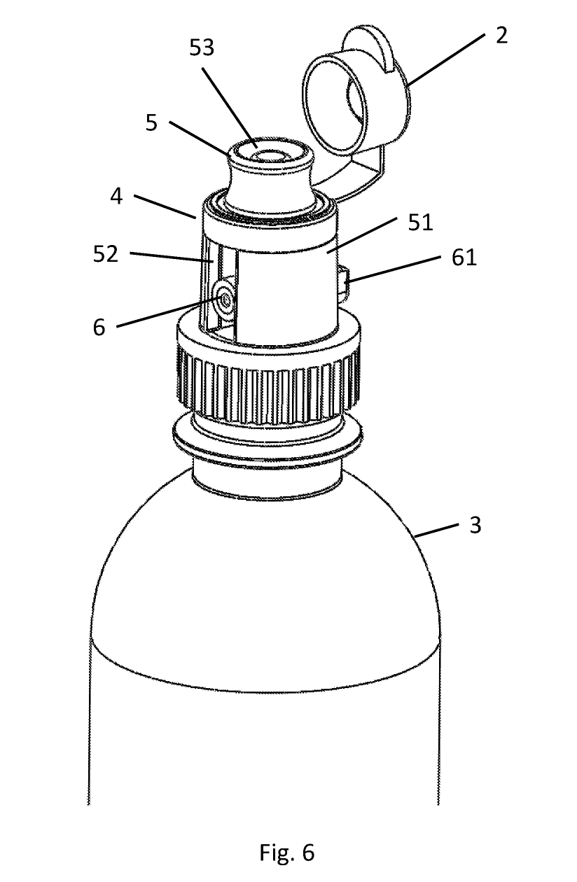

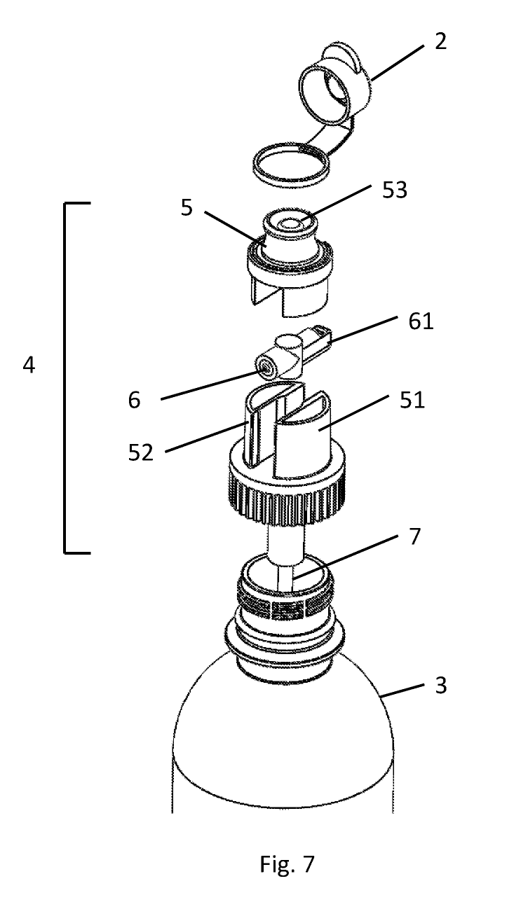

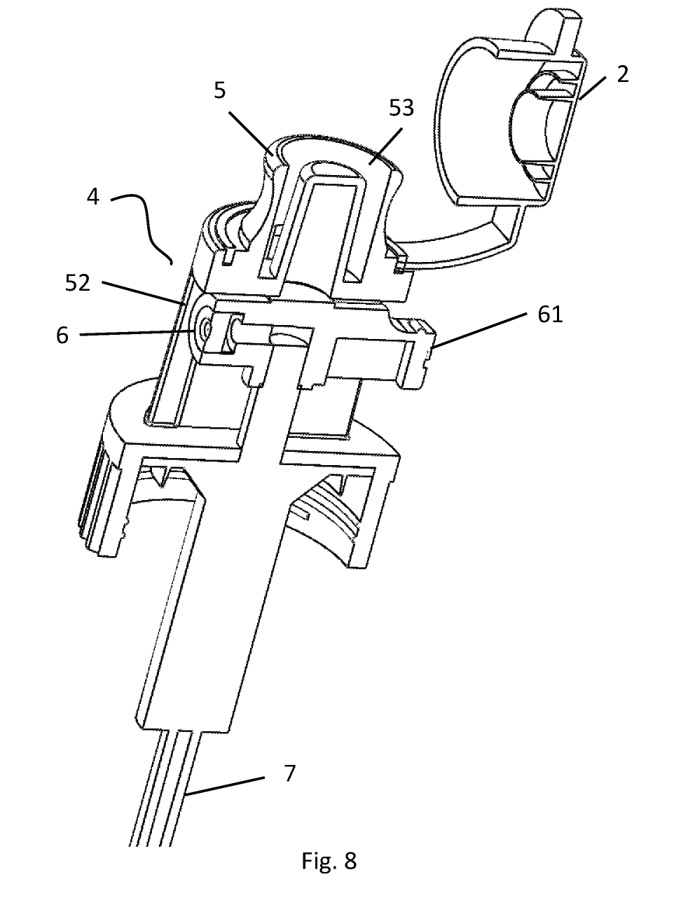

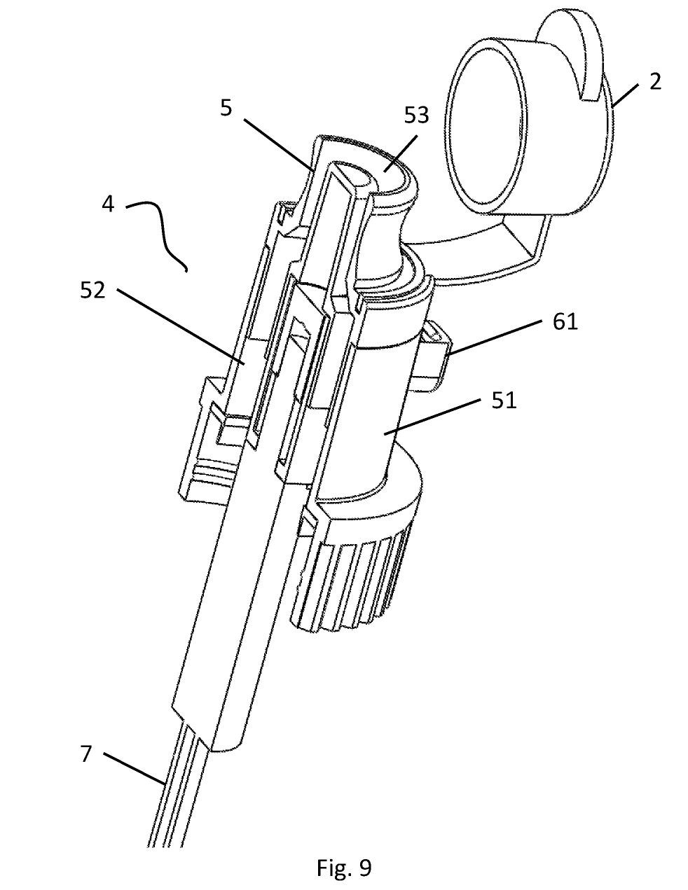

As shown in FIGS. 1 through 9, the dual function top 4 has a fixed nozzle 5 with an opening 53 that functions as a water flow opening and a spray nozzle 6 with a pump actuator 61 that actuates a pump mechanism to force the water contained in the water bottle 3 out through the spray nozzle 6. The fixed nozzle 5 is affixed on top of the spray nozzle 6 and has two water flow paths 51, 52 around the spray nozzle 6 that leads from the water bottle 3 to an opening 53 at its top to enable the water to flow out of the water bottle 3 when the water bottle 3 is inverted. An elongated tube 7 is affixed under the dual function top 4 and extends to near the bottom of the water bottle 3 to enable the extraction of the water from the water bottle 3 through the spray nozzle 6 when the pump actuator 61 is operated to actuate the pump mechanism.

The sports water bottle of the present invention only has a single top that functions both as a drinking opening and also as a pump with a spray nozzle 6. The dual function top 4 may be retrofitted to most preexisting water bottles that may have a threaded cap, a reclosable drinking cap, or a spray nozzle. The sports water bottle of the present invention is multifunctional, low cost, and is easy to operate.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

1: A dual function top for a sports water bottle with mister comprising:
a nozzle defining an opening that is in fluid communication through one or more fluid flow paths with liquid in said sports water bottle;
a spray nozzle with a pump actuator, that is not the nozzle, that actuates a pump mechanism disposed under said nozzle; and
an elongated tube affixed under said pump mechanism and extends into said sports water bottle;
wherein actuation of said pump actuator will spray water out through said spray nozzle.

2: A dual function top for a sports water bottle with mister as in claim 1, further including a flip top cap that covers said opening in said nozzle.

3: A dual function top for a sports water bottle with mister as in claim 2, further including a security/safety tab that covers the spray nozzle and prevents actuation of the pump actuator.

4: A dual function top for a sports water bottle with mister as in claim 1, wherein said nozzle and said spray nozzle are attachable to a container.

5: A dual function top for a sports water bottle with mister comprising:
a fixed nozzle defining an opening that is in fluid communication through two fluid flow paths with liquid in said sports water bottle;
a spray nozzle with a pump actuator, that is not the fixed nozzle, that actuates a pump mechanism disposed under said nozzle between the two fluid flow paths; and
an elongated tube affixed under said pump mechanism and extends into said sports water bottle;
wherein actuation of said pump actuator will spray water out through said spray nozzle.

6: A dual function top for a sports water bottle with mister as in claim 5, further including a flip top cap that covers said opening in said fixed nozzle.

7: A dual function top for a sports water bottle with mister as in claim 6, further including a security/safety tab that covers the spray nozzle and prevents actuation of the pump actuator.

8: A dual function top for a sports water bottle with mister as in claim 5, wherein said fixed nozzle and said spray nozzle are attachable to a container.

9: A sports water bottle with mister comprising:
a container for water with a sealed end and an open end;
a dual function top attached to said open end of said container comprising;
a nozzle defining an opening that is in fluid communication through one or more fluid flow paths with liquid in said container;
a spray nozzle with a pump actuator, that is not the nozzle, that actuates a pump mechanism disposed under said nozzle; and
an elongated tube affixed under said pump mechanism and extends into said container;
wherein actuation of said pump actuator will spray water out through said spray nozzle.

10: A sports water bottle with mister as in claim 9, wherein said container is a plastic cylindrical water bottle with a threaded opening.

11: A sports water bottle with mister as in claim 9, wherein said container is a metallic cylindrical water bottle with a threaded opening.

12: A dual function top for a sports water bottle with mister as in claim 9, further including a flip top cap that covers said opening in said fixed nozzle.

13: A dual function top for a sports water bottle with mister as in claim 12, further including a security/safety tab that covers the spray nozzle and prevents actuation of the pump actuator.
